(19) United States
(12) Patent Application Publication
(10) Pub. No.: US 2025/0336044 A1
(43) Pub. Date: Oct. 30, 2025

(54) IMAGE PROCESSOR AND DEPTH SENSOR INCLUDING THE SAME

(71) Applicant: SK hynix Inc., Gyeonggi-do (KR)

(72) Inventor: Ji Hee HAN, Gyeonggi-do (KR)

(21) Appl. No.: 18/900,895

(22) Filed: Sep. 30, 2024

(30) Foreign Application Priority Data
Apr. 30, 2024 (KR) 10-2024-0057634

(51) Int. Cl. G06T 5/70; G06T 5/50; G06V 20/70

(52) U.S. Cl. CPC G06T 5/70; G06T 5/50; G06V 20/70; G06T 2207/20224; G06V 2201/07

(57) ABSTRACT

Disclosed is an image processor and a depth sensor including the same, and the image processor may include a first processor configured to generate a binary image based on an input image having projected dots and correction threshold information predetermined depending on positions of the projected dots, and a second processor configured to detect the projected dots based on the input image and the binary image.

### CROSS-REFERENCE TO RELATED APPLICATION(S)

This application claims priority under 35 U.S.C. § 119 to Korean Patent Application No. 10-2024-0057634, filed on Apr. 30, 2024, the disclosure of which is incorporated herein by reference in its entirety.

### BACKGROUND

### 1. Field

Various embodiments of the present disclosure relate to a semiconductor design technique, and more particularly, to an image processor that measures a depth and a depth sensor including the same.

### 2. Description of the Related Art

LiDAR, light detection and ranging, is one of depth sensors mainly used to measure a distance, that is, a depth, to a subject. The LIDAR accumulates a hit count value of a laser reflected from the subject in a plurality of time bins and obtains the depth based on a time bin having the largest hit count value among the plurality of time bins.

The laser reflected from the subject is projected in the form of dots through a sensor mounted on the LiDAR. Depending on the distance, that is, the depth, to the subject, the positions of dots projected through the sensor changes, or the intensity of the projected dots decreases.

### SUMMARY

Various embodiments of the present disclosure are directed to an image processor capable of accurately detecting the positions of projected dots when a laser reflected from a subject is projected through a sensor, and a depth sensor including the image processor.

In accordance with an embodiment of the present disclosure, an image processor may include a first processor configured to generate a binary image based on an input image having projected dots and correction threshold information predetermined depending on positions of the projected dots; and a second processor detecting the projected dots based on the input image and the binary image.

In accordance with an embodiment of the present disclosure, an image processor may include: a noise remover configured to generate a third input image from which noise is removed, based on a first input image having projected dots and a second input image not having the projected dots; a first processor configured to generate a binary image based on the third input image and correction threshold information which is predetermined depending on positions of the projected dots; and a second processor configured to detect the projected dots based on the third input image and the binary image.

In accordance with an embodiment of the present disclosure, a depth sensor may include a light emitter configured to emit light; an image sensor configured to sense light reflected from a subject and generate an input image having projected dots according to the reflected light; and an image processor configured to detect the projected dots from the input image based on correction threshold information predetermined depending on positions of the projected dots.

### BRIEF DESCRIPTION OF THE DRAWINGS

FIG. 1 is a block diagram illustrating a depth sensor in accordance with an embodiment of the present disclosure.

FIG. 2 is a block diagram illustrating an example of an image processor illustrated in FIG. 1.

FIG. 3 is a block diagram illustrating a first processor illustrated in FIG. 2.

FIG. 4 is a block diagram illustrating a second processor illustrated in FIG. 2.

FIG. 5 is a block diagram illustrating another example of the image processor illustrated in FIG. 1.

FIG. 6 is a diagram briefly illustrating an operation of the depth sensor in accordance with an embodiment of the present disclosure.

### DETAILED DESCRIPTION

Various embodiments of the present disclosure are described below with reference to the accompanying drawings, in order to describe in detail the embodiments of the present disclosure so that those with ordinary skill in art to which the present disclosure pertains may easily carry out the technical spirit of the present disclosure.

It will be understood that when an element is referred to as being “connected to” or “coupled to” another element, the element may be directly connected to or coupled to the other element, or electrically connected to or coupled to the other element with one or more elements interposed therebetween. In addition, it will also be understood that the terms “comprises,” “comprising,” “includes,” and “including” when used in this specification do not preclude the presence of one or more other elements but may further include or have the one or more other elements, unless otherwise mentioned. In the description throughout the specification, some components are described in singular forms, but the present disclosure is not limited thereto, and it will be understood that the components may be formed in plural.

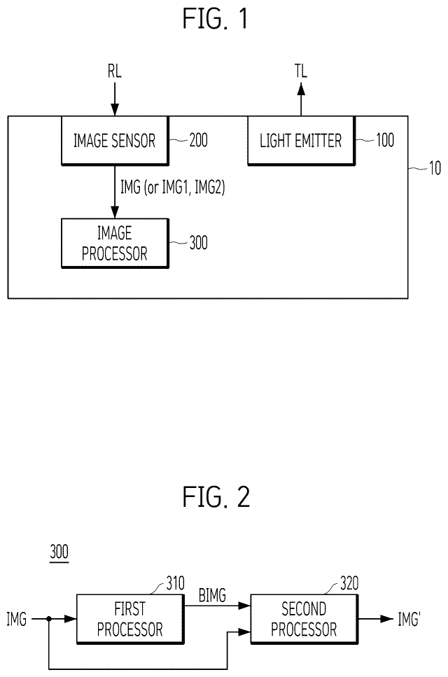

FIG. 1 is a block diagram illustrating a depth sensor 10 in accordance with an embodiment of the present disclosure.

Referring to FIG. 1, the depth sensor 10 may measure a distance, that is, a depth, to at least one subject (not illustrated in the drawing) distributed in a field of view. For example, the depth sensor 10 may include LiDAR. The depth sensor 10 may include a light emitter 100, an image sensor 200, and an image processor 300.

The light emitter 100 may emit output light TL toward the field of view. For example, the light emitter 100 may include a vertical cavity surface emitting laser (VCSEL) driver.

In an embodiment, when the output light TL hits the subject, incident light RL is reflected from the subject. The image sensor 200 may sense the incident light RL reflected from the subject and generate an input image IMG. The incident light RL may appear as projected dots on the image sensor 200. The projected dots may be formed in a mesh shape on the image sensor 200, and the image sensor 200 may generate the input image IMG having the projected dots. In another embodiment, the image sensor 200 may sense the incident light RL reflected from the subject and generate a first input image IMG1 having the projected dots and a second input image IMG2 not having the projected dots. That is, the first input image IMG1 may be generated when the light emitter 100 is in an enabled state, and the second input image IMG2 may be generated when the light emitter 100 is in a disabled state.

In an embodiment, the image processor 300 may accurately detect the projected dots based on the input image IMG. In another embodiment, the image processor 300 may more accurately detect the projected dots based on the first and second input images IMG1 and IMG2. For example, the image processor 300 may use the first input image IMG1 and the second input image IMG2 and more accurately detect the projected dots from an image, that is, a denoised image, from which noise, e.g., an extraneous light component, reflected in the first input image IMG1 is removed. The projected dots may be detected more accurately.

FIG. 2 is a block diagram illustrating an example of the image processor 300 illustrated in FIG. 1.

Referring to FIG. 2, the image processor 300 may include a first processor 310 and a second processor 320.

The first processor 310 may generate a binary image BIMG based on the input image IMG. The binary image BIMG may be an image in which a background area and a subject area of the input image IMG are represented by only two binary image values, i.e., “0” and “1”. The subject area may be first areas corresponding to the projected dots in the input image IMG, and the background area may be at least one area remaining in the input image IMG excluding the first areas.

The second processor 320 may detect the projected dots based on the input image IMG and the binary image BIMG. The second processor 320 may generate an output image IMG′ having detected points corresponding to the projected dots. According to an embodiment of the present disclosure, because the detected points are accurately detected, the projected dots and the detected points may correspond one-to-one. The output image IMG′ may be used instead of the input image IMG when the depth is measured.

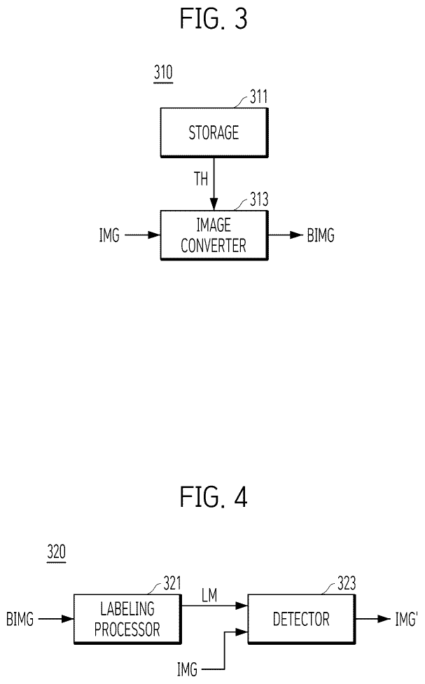

FIG. 3 is a block diagram illustrating the first processor 310 illustrated in FIG. 2.

Referring to FIG. 3, the first processor 310 may include a storage 311 and an image converter 313.

The storage 311 may provide the image converter 313 with correction threshold information TH. The correction threshold information TH may be tuned depending on environment or conditions. For example, the storage 311 may store at least one of first to third threshold information TH1 to TH3 therein. The first threshold information TH1 may include first threshold values according to a distance between a center of the input image IMG and the projected dots. The second threshold information TH2 may include second threshold values according to the distance, that is, the depth, to the subject. The third threshold information TH3 may include third threshold values obtained by combining the first threshold values and the second threshold values. For example, the third threshold information TH3 may include the third threshold values according to a result obtained by multiplying the distance between the center of the input image IMG and the projected dots by the distance, that is, the depth, to the subject. The storage 311 may output one of the first to third threshold information TH1 to TH3 as the correction threshold information TH depending on setting.

The image converter 313 may convert the input image IMG into the binary image BIMG based on the correction threshold information TH. For example, the image converter 313 may generate the binary image BIMG corresponding to the background area and the subject area of the input image IMG, based on the correction threshold information TH which is adaptively set by considering the distance between the center of the input image IMG and the projected dots and/or the distance, that is, the depth, to the subject. The binary image BIMG may be an image in which the background area and the subject area of the input image IMG are represented by only two binary image values, i.e., “0” and “1”.

In an embodiment, when a target image value, that is, a pixel value, included in the input image IMG is greater than a corresponding first threshold value among the first threshold values included in the first threshold information TH1, the target image value may be converted into a binary image value, e.g., “1”, corresponding to the subject area. On the other hand, when the target image value is less than the first threshold value, the target image value may be converted into a binary image value, e.g., “0”, corresponding to the background area.

In another embodiment, when a target image value, that is, a pixel value, included in the input image IMG is greater than a corresponding second threshold value among the second threshold values included in the second threshold information TH2, the target image value may be converted into a binary image value, e.g., “1”, corresponding to the subject area. On the other hand, when the target image value is less than the second threshold value, the target image value may be converted into a binary image value, e.g., “0”, corresponding to the background area.

In yet another embodiment, when a target image value, that is, a pixel value, included in the input image IMG is greater than a corresponding third threshold value among the third threshold values included in the third threshold information TH3, the target image value may be converted into a binary image value, e.g., “1”, corresponding to the subject area. On the other hand, when the target image value is less than the third threshold value, the target image value may be converted into a binary image value, e.g., “0”, corresponding to the background area.

FIG. 4 is a block diagram illustrating the second processor 320 illustrated in FIG. 2.

Referring to FIG. 4, the second processor 320 may include a labeling processor 321 and a detector 323.

The labeling processor 321 may generate a label map LM, which is labeled for each subject, i.e., each of the projected dots, based on the binary image BIMG. For example, the labeling processor 321 may analyze the binary image BIMG for each kernel and generate the label map LM in which a label number is assigned to each of the projected dots according to the analysis result. When the kernel corresponds to a pixel area including 3*3 pixels, the labeling processor 321 may analyze a connection relationship, that is, neighbor connectivity, between a center pixel placed at the center of the 3*3 pixels and each peripheral pixel placed on the periphery of the center pixel and assign the same label number when the analysis result indicates that two pixels are connected to each other. The labeling processor 321 may assign the same label number to at least one pixel included in or corresponding to the same subject area, that is, one of the projected dots, according to the analysis result. In contrast, the labeling processor 321 may assign different label numbers when the analysis result indicates that the two pixels are not connected to each other. The labeling processor 321 may assign different label numbers to pixels included in or corresponding to different subject areas, that is, each of the projected dots, according to the analysis result. The labeling processor 321 may perform the analysis operation when the center pixel has a binary image value, e.g., “1”, corresponding to the subject area, and might not perform the analysis operation when the center pixel has a binary image value, e.g., “0”, corresponding to the background area.

The detector 323 may detect the projected dots based on the label map LM and the input image IMG and generate the output image IMG′ corresponding to the input image IMG. For example, the detector 323 may detect each of the projected dots by selecting a center point of the label for each subject included in the label map LM. The center point may correspond to a target pixel among pixels included in the label, the target pixel being indicated by an average coordinate value of horizontal axis coordinate values of the pixels and an average coordinate value of vertical axis coordinate values of the pixels.

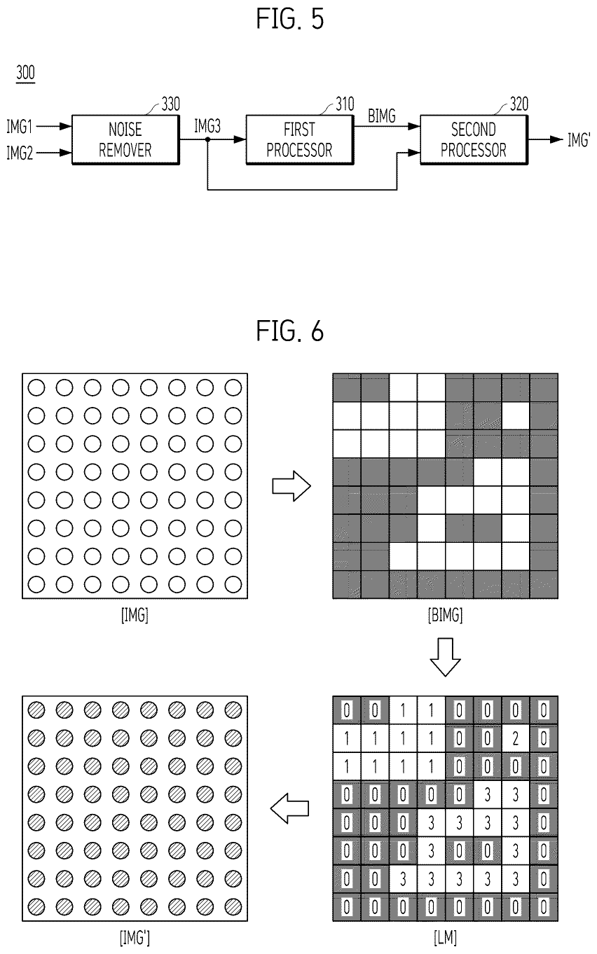

FIG. 5 is a block diagram illustrating another example of the image processor 300 illustrated in FIG. 1.

Referring to FIG. 5, the image processor 300 may include a noise remover 330, a first processor 310, and a second processor 320.

Because the first processor 310 and the second processor 320 may be designed in the same manner as those illustrated in FIG. 2, only the noise remover 330 is described below.

The noise remover 330 may generate a third input image IMG3, from which the noise is removed, based on the first input image IMG1 and the second input image IMG2. The first input image IMG1 may have the projected dots according to the incident light RL. That is, the first input image IMG1 may be generated when the light emitter 100 emits the output light TL, that is, when the light emitter 100 is enabled. The second input image IMG2 might not have the projected dots. That is, the second input image IMG2 may be generated when the light emitter 100 does not emit the output light TL, that is, when the light emitter 100 is disabled. For example, the noise controller 330 may generate the third input image IMG3 by performing a subtraction operation of subtracting the second input image IMG2 from the first input image IMG1.

Hereinafter, an operation of the depth sensor 10 in accordance with an embodiment of the present disclosure, which has the above-described configuration, is described with reference to FIG. 6.

Referring to FIG. 6, when the light emitter 100 emits the output light TL toward the field of view, the incident light RL reflected from the subject may be projected in the form of dots onto the image sensor 100. The image sensor 200 may generate the input image IMG having projected dots based on the incident light RL. In another embodiment, the image sensor 200 may generate the first input image IMG1 having the projected dots and the second input image IMG2 not having the projected dots, based on the incident light RL.

In an embodiment, the image processor 300 may accurately detect the projected dots based on the input image IMG and generate the output image IMG′ having detected points corresponding to the projected dots.

In another embodiment, the image processor 300 may more accurately detect the projected dots based on the first and second input images IMG1 and IMG2 and generate the output image IMG′ having detected points corresponding to the projected dots. For example, the image processor 300 may use the first input image IMG1 and the second input image IMG2 to detect the projected dots while noise reflected in the first input image IMG1 is removed.

An operation of the image processor 300 is described in more detail as follows. The operation of the image processor 300 according to an embodiment, which is illustrated in FIG. 2, is representatively described.

The storage 311 may provide the image converter 313 with the correction threshold information TH. The storage 311 may store the first to third threshold information TH1 to TH3 therein. The first threshold information TH1 may include first threshold values according to a distance between a center of the input image IMG and the projected dots. The second threshold information TH2 may include second threshold values according to a distance, that is, a depth, to the subject. The third threshold information TH3 may include third threshold values according to a result obtained by multiplying the distance between the center of the input image IMG and the projected dots by the distance, that is, the depth, to the subject. The storage 311 may output one of the first to third threshold information TH1 to TH3 as the correction threshold information TH depending on setting.

The image converter 313 may convert the input image IMG into the binary image BIMG based on the correction threshold information TH. For example, the image converter 313 may generate the binary image BIMG corresponding to the background area and the subject area of the input image IMG, based on the correction threshold information TH which is adaptively set by considering the distance between the center of the input image IMG and the projected dots and/or the distance, that is, the depth, to the subject. The binary image BIMG may be an image in which the background area and the subject area of the input image IMG are represented by only two binary image values, i.e., “0” and “1”.

In an embodiment, when a target image value, that is, a pixel value, included in the input image IMG is greater than a corresponding first threshold value among the first threshold values included in the first threshold information TH1, the target image value may be converted into a binary image value, e.g., “1”, corresponding to the subject area. On the other hand, when the target image value is less than the first threshold value, the target image value may be converted into a binary image value, e.g., “0”, corresponding to the background area.

In another embodiment, when a target image value, that is, a pixel value, included in the input image IMG is greater than a corresponding second threshold value among the second threshold values included in the second threshold information TH2, the target image value may be converted into a binary image value, e.g., “1”, corresponding to the subject area. On the other hand, when the target image value is less than the second threshold value, the target image value may be converted into a binary image value, e.g., “0”, corresponding to the background area.

In yet another embodiment, when a target image value, that is, a pixel value, included in the input image IMG is greater than a corresponding third threshold value among the third threshold values included in the third threshold information TH3, the target image value may be converted into a binary image value, e.g., “1”, corresponding to the subject area. On the other hand, when the target image value is less than the third threshold value, the target image value may be converted into a binary image value, e.g., “0”, corresponding to the background area.

In FIG. 6, the binary image BIMG is shown in “black” and “white” instead of the two binary image values, i.e., “0” and “1”. The subject area may be first areas corresponding to the projected dots in the input image IMG, which is shown in “white” in the binary image BIMG of FIG. 6, and the background area may be at least one area excluding the first areas in the input image IMG, which is shown in “black” in the binary image BIMG of FIG. 6. It is noted that the binary image BIMG illustrated in FIG. 6 is a portion of the input image IMG illustrated in FIG. 6.

The labeling processor 321 may generate a label map LM, in which the projected dots are labeled, based on the binary image BIMG. For example, the labeling processor 321 may analyze the binary image BIMG for each kernel and generate the label map LM in which a label number is assigned to each of the projected dots according to the analysis result. When the kernel corresponds to a pixel area including 3*3 pixels, the labeling processor 321 may analyze a connection relationship, that is, neighbor connectivity, between a center pixel placed at the center of the 3*3 pixels and each peripheral pixel placed on the periphery of the center pixel and assign the same label number when the analysis result indicates that two pixels are connected to each other. The labeling processor 321 may assign the same label number to at least one pixel included in or corresponding to the same subject area, that is, one of the projected dots, according to the analysis result. In contrast, the labeling processor 321 may assign different label numbers when the analysis result indicates that the two pixels are not connected to each other. The labeling processor 321 may assign different label numbers to pixels included in or corresponding to different subject areas, that is, each of the projected dots, according to the analysis result. The labeling processor 321 may perform the analysis operation when the center pixel has a binary image value, e.g., “1”, corresponding to the subject area, and might not perform the analysis operation when the center pixel has a binary image value, e.g., “0”, corresponding to the background area. According to an embodiment of the present disclosure, because the labeling processor 321 uses the binary image BIMG, the analysis operation may be easily omitted when unnecessary, and accordingly, data processing simplicity of the second processor 320 may be improved.

The detector 323 may detect the projected dots based on the label map LM and the input image IMG and generate the output image IMG′ corresponding to the input image IMG. For example, the detector 323 may detect each of the projected dots by selecting a center point of the label for each subject included in the label map LM. The center point may correspond to a target pixel among pixels included in the label for each subject, the target pixel being indicated by an average coordinate value of horizontal axis coordinate values of the pixels and an average coordinate value of vertical axis coordinate values of the pixels.

According to an embodiment of the present disclosure, when a laser reflected from a subject is projected onto a sensor, positions of projected dots can be accurately detected.

According to an embodiment of the present disclosure, when a laser reflected from a subject is projected onto a sensor, positions of projected dots can be automatically and accurately detected, which makes it possible to improve operational reliability of a depth sensor.

While the present disclosure has been illustrated and described with respect to specific embodiments, the disclosed embodiments are provided for the description, and not intended to be restrictive. Further, it is noted that the embodiments of the present disclosure may be achieved in various ways through substitution, change, and modification that fall within the scope of the following claims, as those skilled in the art will recognize in light of the present disclosure. The embodiments may be combined to form additional embodiments.

What is claimed is:

1. An image processor comprising:
a first processor configured to generate a binary image based on an input image having projected dots and correction threshold information predetermined depending on positions of the projected dots; and
a second processor configured to detect the projected dots based on the input image and the binary image.

2. The image processor of claim 1, wherein the first processor includes:
a storage configured to store the correction threshold information; and
an image converter configured to convert the input image into the binary image based on the correction threshold information.

3. The image processor of claim 2, wherein:
the storage is configured to store first to third threshold information and output one of the first to third threshold information as the correction threshold information depending on setting;
the first threshold information includes first threshold values according to a distance between a center of the input image and the projected dots;
the second threshold information includes second threshold values according to a distance to a subject; and
the third threshold information includes third threshold values obtained by combining the first threshold values and the second threshold values.

4. The image processor of claim 1, wherein the second processor includes:
a labeling processor configured to generate a label map, in which the projected dots are labeled, based on the binary image; and
a detector configured to detect the projected dots based on the label map and the input image.

5. The image processor of claim 4, wherein the detector is configured to detect each of the projected dots by selecting a center point of at least one label included in the label map.

6. The image processor of claim 5, wherein the center point corresponds to a target pixel among pixels included in the at least one label, the target pixel being indicated by an average coordinate value of horizontal axis coordinate values of the pixels and an average coordinate value of vertical axis coordinate values of the pixels.

7. An image processor comprising:
a noise remover configured to generate a third input image from which noise is removed, based on a first input image having projected dots and a second input image not having the projected dots;
a first processor configured to generate a binary image based on the third input image and correction threshold information which is predetermined depending on positions of the projected dots; and
a second processor configured to detect the projected dots based on the third input image and the binary image.

8. The image processor of claim 7, wherein the noise remover is configured to generate the third input image by subtracting the second input image from the first input image.

9. The image processor of claim 7, wherein the first processor includes:
a storage configured to store the correction threshold information; and
an image converter configured to convert the third input image into the binary image based on the correction threshold information.

10. The image processor of claim 9, wherein:
the storage is configured to store first to third threshold information and output one of the first to third threshold information as the correction threshold information depending on a setting;
the first threshold information includes first threshold values according to a distance between a center of the input image and the projected dots;
the second threshold information includes second threshold values according to a distance to a subject; and
the third threshold information includes third threshold values obtained by combining the first threshold values and the second threshold values.

11. The image processor of claim 7, wherein the second processor includes:
a labeling processor configured to generate a label map, in which each of the projected dots is labeled, based on the binary image; and
a detector configured to detect the projected dots based on the label map and the third input image.

12. The image processor of claim 11, wherein the detector is configured to detect each of the projected dots by selecting a center point of at least one label included in the label map.

13. The image processor of claim 12, wherein the center point corresponds to a target pixel among pixels included in the at least one label, the target pixel being indicated by an average coordinate value of horizontal axis coordinate values of the pixels and an average coordinate value of vertical axis coordinate values of the pixels.

14. A depth sensor comprising:
a light emitter configured to emit light;
an image sensor configured to sense light reflected from a subject and generate an input image having projected dots according to the reflected light; and
an image processor configured to detect the projected dots from the input image based on correction threshold information predetermined depending on positions of the projected dots.

15. The depth sensor of claim 14,
wherein the image sensor is further configured to generate another input image not having the projected dots, and
wherein the image processor is configured to detect the projected dots while noise reflected in the input image is removed using the another input image.

16. The depth sensor of claim 14, wherein the image processor includes:
a first processor configured to generate a binary image based on the input image and the correction threshold information; and
a second processor configured to detect the projected dots based on the input image and the binary image.

17. The depth sensor of claim 16, wherein the first processor includes:
a storage configured to store the correction threshold information; and
an image converter configured to convert the input image into the binary image based on the correction threshold information.

18. The depth sensor of claim 17, wherein:
the storage is configured to store first to third threshold information and output one of the first to third threshold information as the correction threshold information depending on setting;
the first threshold information includes first threshold values according to a distance between a center of the input image and the projected dots;
the second threshold information includes second threshold values according to a distance to the subject; and
the third threshold information includes third threshold values obtained by combining the first threshold values and the second threshold values.

19. The depth sensor of claim 16, wherein the second processor includes:
a labeling processor configured to generate a label map, in which the projected dots are labeled, based on the binary image; and
a detector configured to detect the projected dots based on the label map and the input image.

20. The depth sensor of claim 19, wherein the detector is configured to detect each of the projected dots by selecting a center point of at least one label included in the label map.

21. The depth sensor of claim 20, wherein the center point corresponds to a target pixel among pixels included in at least one the label, the target pixel being indicated by an average coordinate value of horizontal axis coordinate values of the pixels and an average coordinate value of vertical axis coordinate values of the pixels.
